(19) United States
(12) Patent Application Publication
(10) Pub. No.: US 2003/0005450 A1
(43) Pub. Date: Jan. 2, 2003

(54) Method and system for connecting high speed data communication signals to a residentual gateway

(76) Inventor: Gordon Smith, Sandy, UT (US)

Correspondence Address: MCCARTHY & SADLER, LC, Suite 100, 39 Exchange Place, Salt Lake City, UT, 84111, US

(21) Appl. No.: 09/897,814

(22) Filed: Jul. 1, 2001

(51) Int. Cl. H04N 7/18; H04N 7/16; H04L 12/28; H04L 12/56

(52) U.S. Cl. 725/78; 725/74; 725/135; 370/908; 370/401

(57) ABSTRACT

A communication method and system are provided which enables the communication of data and television signals on a residential gateway network while avoiding the degradation of VDSL signals. This invention employs a new directional coupler that permits coupling between input and output ports, but only limited coupling to a television port.

### BACKGROUND OF THE INVENTION

1. Field of the Invention

This invention relates to methods and systems for providing high-speed data connections to a home. More specifically, this invention relates to methods and systems for providing high-speed data connections to a home, which makes use of existing coaxial cable television (CATV) cabling while eliminating signal degradation common to the use of a CATV splitter.

2. Description of Related Art

A variety of home signal and data connection methods and systems are well known in the art. Generally, these methods and systems do not provide for the integration of audio/visual (television) channel signals and high speed Internet data channel signals without degrading the high-speed data signals.

The reader is referred to the following U.S. patent documents for general background material. Each of these patents is hereby incorporated by reference in its entirety for the material contained therein.

U.S. Pat. No. 5,555,244 describes a scalable multimedia network that provides integrated networking of data, voice, video and image services over a variety of access facilities.

U.S. Pat. Nos. 5,572,517 and 5,696,765 describe a hybrid medium access control system that is configurable to the type of communication required to support a desired application or service.

U.S. Pat. No. 5,762,552 describes an interactive real-time network gaming system that enables a plurality of players to place wagers on a real-time game of chance being conducted in a casino via a distributed network system.

U.S. Pat. Nos. 5,808,767, 5,864,415 and 5,880,864 describe a fiber optic network that comprises an optical fiber connection from a central office to an intelligent interface device in the subscriber's premises.

U.S. Pat. No. 5,841,468 describes a system and method for isolating data messages received from subscribers in a CATV system.

U.S. Pat. No. 5,847,751 describes a network architecture for delivery of broadcast and interactive digital services over a hybrid fiber-coax distribution system.

U.S. Pat. No. 5,864,284 describes a coupling system for transferring an RF signal to and from a high-voltage cable of a power distribution system.

U.S. Pat. No. 5,892,910 describes an adaptive protocol CATV communication system embodied in a decentralized communication arrangement, wherein the communicating nodes are located at various points within the CATV system.

U.S. Pat. No. 5,905,586 describes a system and method for providing two-way optical communications between a first location and at least one secondary location.

U.S. Pat. No. 6,040,759 describes a communication system for providing broadband multimedia services using one or more high-voltage cables of a power distribution network.

U.S. Pat. No. 6,081,533 describes a method for enhancing the functionalities of a subscriber terminal unit or ADSL terminal unit through the use of different types of application interface modules.

### SUMMARY OF INVENTION

It is desirable to provide a method and system for connecting high-speed data communications to a residential gateway. It is particularly desirable to provide a method and system for connecting high-speed data communications to a residential gateway that addresses the degradation of VDSL signals through the use of a directional coupler.

Accordingly, it is an object of this invention to provide a method and system for connecting high-speed data communications to a residential gateway that avoids or reduces VDSL signal degradation.

Another object of this invention is to provide a method and system for connecting high-speed data communications to a residential gateway that uses a directional coupler.

A further object of this invention is to provide a method and system for connecting high-speed data communications to a residential gateway wherein a directional coupler having a high pass television filter.

A still further object of this invention is to provide a method and system for connecting high-speed data communications to a residential gateway, which passes signals above approximately 100 kHz with little if any back loss between the entry point and the gateway ports.

It is another object of this invention to provide a method and system for connecting high speed data communications to a residential gateway that passes DSL, TV and Remote Antenna Port (RAP) signals with good fidelity between the gateway and the entry point and passes only TV and RAP signals between the entry point and the television port.

It is a still further object of this invention to provide a method and system for connecting high speed data communications signals to a residential gateway that keeps devices connected to the television port from interfering or distorting DSL signals passing back and forth between the entry point and the residential gateway.

Additional objects, advantages and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following descriptions wherein there is shown and described the preferred embodiment of this invention. As it will be realized, this invention is capable of other different embodiments, and in its several details and specific electronic circuits, is capable of modification in various aspects without departing from the concept of this invention. Accordingly, the objects, drawings and descriptions should be regarded as illustrative in nature and not as restrictive.

### BRIEF DESCRIPTION OF DRAWINGS

The accompanying drawings incorporated in and forming a part of the specification, illustrate a preferred embodiment of the present invention. Some, although not all, alternative embodiments are described in the following description. In the drawings: FIG. 1 is a block diagram of a typical home wired with a splitter in the main line.

FIG. 2 is a block diagram of a typical home system wired with the directional coupler of this invention.

FIG. 3 is a detailed block diagram of the preferred directional coupler of this invention.

Reference will now be made in detail to the present preferred embodiment of the invention, an example of which is illustrated in the accompanying drawings.

### DETAILED DESCRIPTION

This invention is a method and system for providing high speed data access in a multimedia residential gateway. In particular, this invention provides a system for distributing cable high-speed data access through a residence having or capable of having cable television service.

For the purposes of this disclosure the abbreviation NID shall be interpreted to mean Network Interface Device, the abbreviation RAP shall be interpreted to mean Remote Antenna Port, and the abbreviation RAM shall be interpreted to mean Remote Antenna Multiplexer.

FIG. 1 shows a block diagram of a typical home wired with a splitter in the main line. The residential gateway 100 provides the connection for cable television, with the gateway 100 located in close proximity to Television #1 106. Between the gateway 100 and Television #1 106 are a 3-way Combiner 102, which receives three signals 101 from the gateway 100, and Splitter #2 104, which receives the combined signal 103 from the 3-way Combiner 102. Splitter #2 104 provides a first output 105 and a second output 107. The first output 105 of Splitter #2 is received by Television #1 106. The second output 107 of Splitter #2 104 is received by RAM 109. A fourth signal 108 from the gateway 100 is also receive by RAM 109. A fifth signal 110 from the gateway 100 is input to Balun #2 111. The output 112 of Balun #2 111 and the output 113 of RAM 109 are received by Diplexer #2 114. The output 115 of Diplexer #2 114 is connected to the input of the Main Line Splitter 116, which provides a first output 117 to a first RAP 118, the output 136 of which is provided to Television #2 119. The second output 120 of the Main Line Splitter 116 is connected to Duplexer #1 121, the other input 122 of which is connected to the output of Balun #1 123. Balun #1 receives its input 124 from a Network Interface Device 125. A second output 1 26 from Duplexer #1 121 is connected to the input of Splitter #1 127. Splitter #1 127 provides two outputs 128, 132. The first of these two outputs 128 is connected to a second RAP 129 which is connected 130 to Television #3 131. While the second of these outputs 132 is connected to a third RAP 133, the output 134 of which is connected to Television #4 135. In this typical system, the Main Line Splitter 116 is located between the entry point and the residential gateway 100. This approach typically leads to the degradation of VDSL signals, because generally the splitter's bandwidth (typically 5 to 1000 MHz) does not pass the VDSL signals, which have a bandwidth requirement of approximately 150 KHz to 10 MHz, or if the splitter has a sufficiently wide bandwidth to pass VDSL signals, the outer ports of the splitter, which reflect back onto the VDSL paths, fail to have sufficiently wide bandwidths.

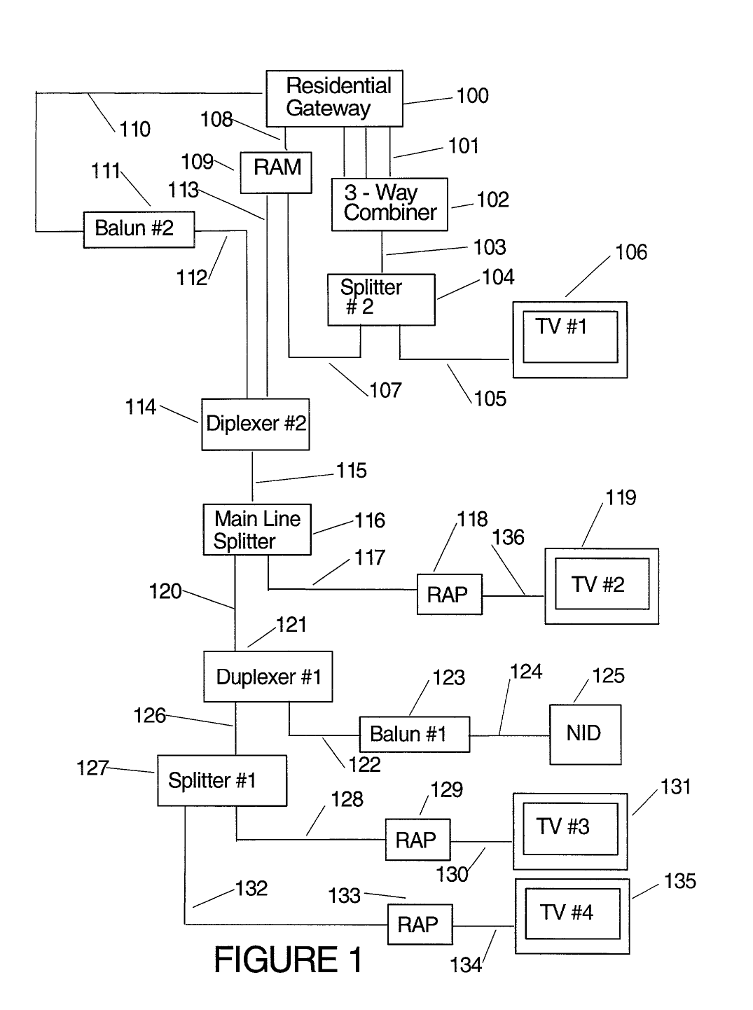

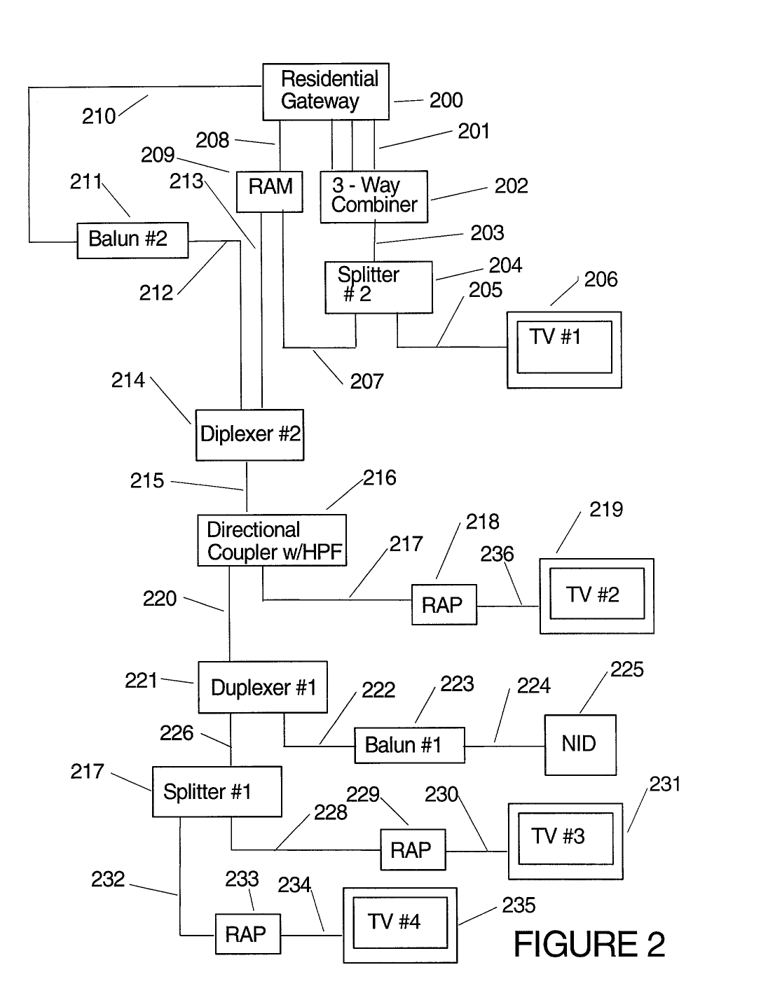

FIG. 2 shows a block diagram of a typical home system wired with the directional coupler 216 of this invention rather than the Main Line Splitter 116 of FIG. 1. Between the gateway 200 and Television #1 206 are a 3-way Combiner 202, which receives three signals 201 from the gateway 200, and Splitter #2 204, which receives the combined signal 203 from the 3-way Combiner 202. The three signals 201 from the gateway 200 and the combined signal 203 are preferably connected using standard CATV coax cable. Splitter #2 204 provides a first output 205 and a second output 207. In the preferred system of this invention, the first output 205 and the second output 207 are connected using standard CATV coax cable. The first output 205 of Splitter #2 204 is received by Television #1 206. The second output 207 of Splitter #2 204 is received by RAM 209. A fourth signal 208, which preferably is connected, using a specific RAM to gateway cable, from the gateway 200 is also receive by RAM 209. A fifth signal 210 from the gateway 200 is input to Balun #2 211. In the present preferred embodiment, this fifth signal 210 is conveyed using a category 5 cable. The output 212 of Balun #2 211 and the output 213 of RAM 209 are received by Diplexer #2 214. The output 215 of Diplexer #2 214 is connected to the input of the Directional Coupler 216, which provides a first output 217 to a first RAP 218, the output 236 of which is provided to Television #2 219. The second output 220 of the Directional Coupler 216 is connected to Duplexer #1 221, the other input 222 of which is connected to the output of Balun #1 223. Balun #1 receives its input 224 from a Network Interface Device 225. A second output 226 from Duplexer #1 221 is connected to the input of Splitter #1 227. Splitter #1 227 provides two outputs 228, 232. The first of these two outputs 228 is connected to a second RAP 229 which is connected 230 to Television #3 231. While the second of these outputs 232 is connected to a third RAP 233, the output 234 of which is connected to Television #4 235. The preferred cable used for the connections from the directional coupler 214, the diplexer's 221, 214 and Splitter #1 217 are CATV coax cable. The preferred connection between the Network Interface Device 225 to Balun #1 is a category 5 cable.

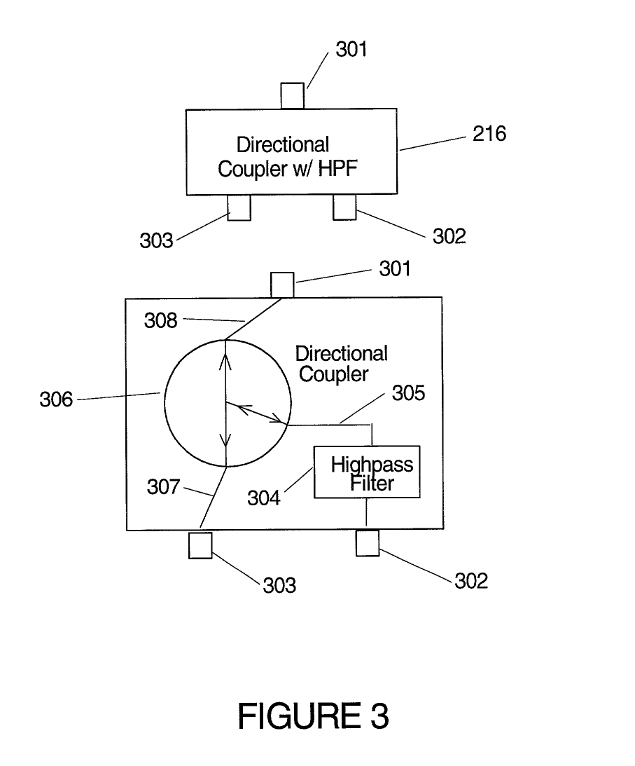

FIG. 3 shows a detailed block diagram of the preferred directional coupler 216 of this invention. This preferred directional coupler 216 of this invention is a device 306 having four ports: an Input Port 308, which is connected electronically 308 to an Entry Point 301, an Output Port 307, which is connected electronically to a Gateway Point 303, a Coupled Port 305, and an Isolation Port. The Isolation Port (not shown) is usually terminated with a resistor. Signals pass with little loss (typically less than or equal to 0.5 dB) back and forth between the Input 308 and Output 307 Ports. Signals passing from the Input Port 308 to the Output Port 307 are coupled to the Coupled Port 305, typically with loss of only about 10 dB, and are isolated from the Isolated Port with an attenuation of the input signal of about 30 to 40 dB. In the present preferred embodiment of this invention, the Coupled Port 305 is followed with a high pass filter 304 that passes signal frequencies greater than 50 MHz (television frequencies) to a Television Point 302. With this directional coupler 216 installed in the main line to the Residential Gateway, all signals above approximately 100 kHz pass will little loss back and forth between the Entry 301 and the Gateway 303 Ports. Approximately 10 dB of attenuation of signals greater than 50 MHz is provided between the Entry Point 301 and the Television Point 302. With the high pass filter 304, there is provided approximately 60 dB of attenuation of frequencies less than 10 MHz (DSL frequencies). In sum, the DSL, TV and RAP signals pass with good fidelity between the Gateway 303 and the Entry Point 301, and only TV and RAP signals pass back and forth between the Entry Point 301 and the Television Point 302.

The previous described preferred embodiments of the invention are to be considered in all respects only as illustrative and not as restrictive. Although the embodiments shown describe particular components in particular connection configurations, the invention is not limited thereto. The scope of this invention is indicated by the appended claims rather than by the foregoing description. All systems and devices, which come directly within the claims or within the meaning and range of equivalency of the claims, are to be embraced as being within the scope of protection of this invention.

1. A residential data communication system, comprising:
(A) a residential gateway providing a communication signal;
(B) a television receiving a video signal, wherein said video signal is derived from said communication signal;
(C) a directional coupler receiving an entry signal, a gateway signal and producing a television signal, wherein said gateway signal is derived from said residential gateway and wherein said entry signal is derived from a network interface device.

2. A directional coupler, comprising:
(A) an entry point;
(B) an input port electrically connected to said entry point;
(C) a coupler device electrically connected to said input port and to an output port and to a coupled port,
(D) a gateway point electrically connected to said output port;
(E) a filter, having a first and a second connection, wherein said first connection is electrically connected to said coupled port; and
(F) a television point electrically connected to said second connection of said filter.

3. A method for coupling communication signals, comprising:
(A) receiving a gateway signal;
(B) coupling said gateway signal to an network data signal;
(C) selecting television signals; and
(D) coupling said selected television signals to a television port.
